(19) United States
(12) Patent Application Publication
(10) Pub. No.: US 2016/0210643 A1
(43) Pub. Date: Jul. 21, 2016

(54) METHOD AND SURVEY SERVER FOR PERFORMING A WEB SURVEY BASED ON BEHAVIORAL DATA SPECIFIC TO A WEB PAGE

(71) Applicant: IPerceptions inc., Montreal (CA)

(72) Inventors: Lane COCHRANE, Kirkland (CA); Audry LAROCQUE, Ville Mont-Royal (CA); Matthew BUTLER, Montreal (CA); Derek ZAKAIB, St-Lambert (CA)

(21) Appl. No.: 14/597,288

(22) Filed: Jan. 15, 2015

(51) Int. Cl. G06Q 30/02

(52) U.S. Cl. CPC G06Q 30/0203

(57) ABSTRACT

A method and survey server for performing a web survey based on behavioral data specific to a web page. Behavioral data related to a specific web page of a website are collected from a plurality of user devices. The behavioral data are representative of a series of actions performed by a user of each of the plurality of user devices while visiting the specific web page. A processing unit of the survey server compares the behavioral data collected from the plurality of user devices with reference behavioral data. The processing unit further determines whether to invite or not the user of a particular user device among the plurality of user devices to participate to a web survey related to the specific web page, based on a result of the comparison.

### TECHNICAL FIELD

The present disclosure relates to the field of website analytics via web surveys. More specifically, the present disclosure relates to a method, computer program product and survey server for performing a web survey based on behavioral data specific to a web page.

### BACKGROUND

The usage of web sites to make dedicated web content available to a large public is now prevalent, in relation with the widespread usage of fixed Internet access and mobile Internet access. In particular, e-commerce has become a major component of the economy, in a plurality of business areas such as for example travel agencies, on-line banking, electronics and multimedia retail sales, etc. Web sites in relation to professional services and administration are now also widely used to reach prospects and users.

There is a growing need for the owner or administrator of a web site to better understand whether the visitors are satisfied with their interactions with the web site, and to rapidly detect and identify operational issues affecting the user experience of the visitors. One way to obtain such information is to invite some of the visitors to participate to a web survey during or after the browsing of the web site. By gathering answers to the web survey over a panel of visitors, the user experience with respect to the visit of the web site can be evaluated.

However, a particular operational issue may affect only one particular web page of the website, which is visited at a particular moment during the browsing session of a visitor. Thus, filing the web survey at a later moment of the browsing session (e.g. when leaving the web site) can be less effective, since the visitor may not remember the particular web page with the operational issue, the exact nature of the operational issue, etc. Furthermore, a visitor having experienced the operational issue may not be invited to participate to the survey related to the web site, or may participate to the web survey before the issue has occurred. A more efficient way to collect relevant user feedback related to the user experience of visitors of a particular web page is to detect the potential occurrence of an issue with the particular web page, and to (immediately) trigger a web survey focused on this particular web page.

There is therefore a need for a method, computer program product and survey server for performing a web survey based on behavioral data specific to a web page of a website.

### SUMMARY

According to a first aspect, the present disclosure provides a method for performing a web survey based on behavioral data specific to a web page. The method comprises collecting behavioral data related to a specific web page of a website from a plurality of user devices. The behavioral data are representative of a series of actions performed by a user of each of the plurality of user devices while visiting the specific web page. The method comprises comparing, by a processing unit of a survey server, the behavioral data collected from the plurality of user devices with reference behavioral data. The method further comprises determining, by the processing unit, whether to invite or not the user of a particular user device among the plurality of user devices to participate to a web survey related to the specific web page, based on a result of the comparison.

According to a second aspect, the present disclosure provides a computer program product comprising instructions deliverable via an electronically-readable media, such as storage media and communication links. The instructions comprised in the computer program product, when executed by a processing unit of a survey server, provide for performing a web survey based on behavioral data specific to a web page, according to the aforementioned method.

According to a third aspect, the present disclosure provides a survey server comprising a communication interface for exchanging data with user devices, memory for storing reference behavioral data, and a processing unit. The processing unit compares behavioral data collected from a plurality of user devices with the reference behavioral data. The collected behavioral data are representative of a series of actions performed by a user of each of the plurality of user devices while visiting a specific web page of a website. The processing unit further determines whether to invite or not the user of a particular user device among the plurality of user devices to participate to a web survey related to the specific web page, based on a result of the comparison.

In a particular aspect, an invitation to participate to the web survey is sent to the particular user device when a determination to invite the user of the particular user device to participate to the web survey has been made. Survey participation data are further received from the particular user device in response to the invitation to participate to the web survey.

### BRIEF DESCRIPTION OF THE DRAWINGS

Embodiments of the disclosure will be described by way of example only with reference to the accompanying drawings, in which:

FIG. 1 illustrates a method for performing a web survey based on behavioral data specific to a web page;

FIG. 2 illustrates a survey server for implementing the method of FIG. 1;

FIG. 3 illustrates the display of a web page in a browser of a user device represented in FIG. 2;

FIG. 4 illustrates the display of a Graphical User Interface for inviting a user to participate to the web survey referred to in FIG. 1;

FIG. 5 illustrates the display of a Graphical User Interface for participating to the web survey referred to in FIG. 1; and

FIG. 6 illustrates steps for performing the web survey referred to in FIG. 1;

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the detection of a potential issue with a specific web page of a website. The detection is based on behavioral data collected for this specific web page. The present disclosure also address the triggering of a web survey based on the collected behavioral data, to further collect user feedback on the potential issue with the specific web page.

The following terminology is used throughout the present disclosure:
Web survey: A web survey aims at collecting user feedback related to the browsing of a web site by a user. The term survey is used in a generic manner, and may include surveys, questionnaires, comment cards, etc. In the context of the present disclosure, the user feedback focuses on a specific web page of the web site, for which a potential issue has been detected.
Behavioral data: Data representative of a series of actions performed by a user while visiting a website. Behavioral data include visited web pages, time spent on the visited web pages, specific interactions with the visited web pages, etc. The behavioral data are generally collected from the user device by an analytic server, which further processes the data collected for a plurality of user devices of visitors to the web site.

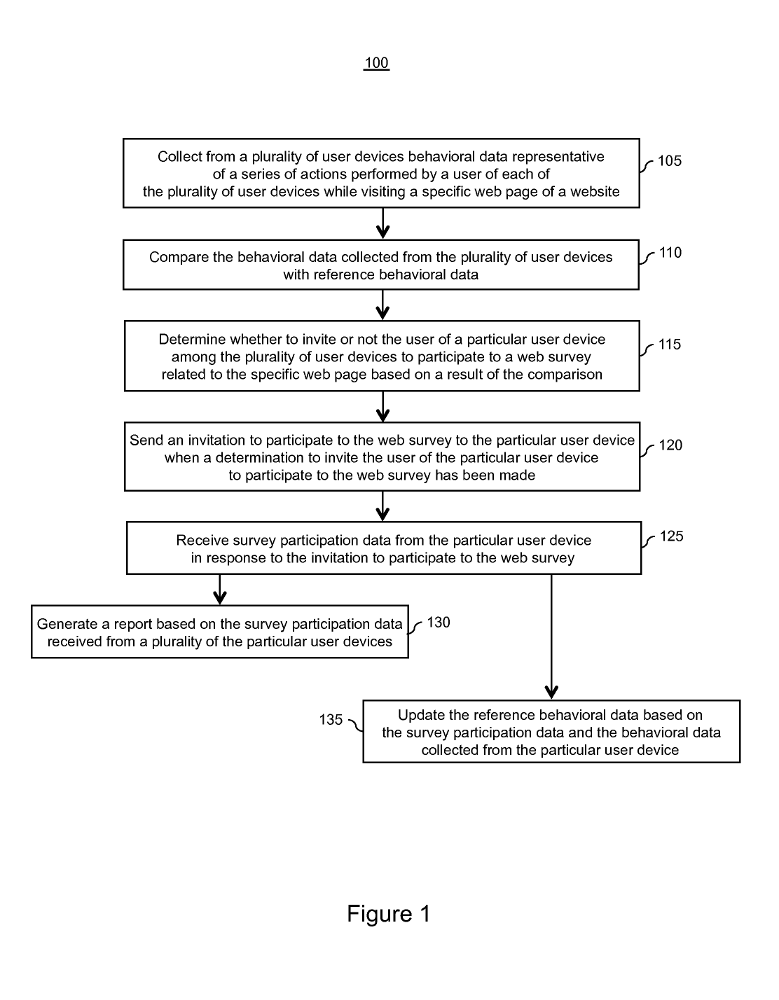

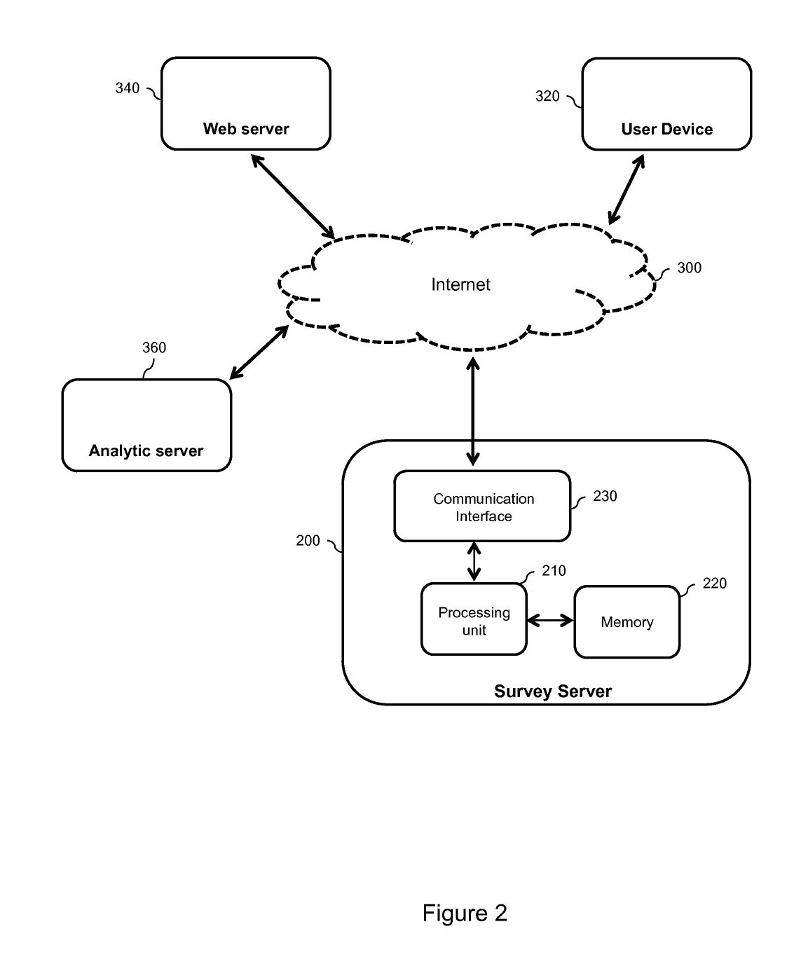

Referring now concurrently to FIGS. 1 and 2, a method 100 and a survey server 200 for performing a web survey based on behavioral data specific to a web page are represented.

The survey server 200 comprises a processing unit 210, having one or more processors (not represented in FIG. 2 for simplification purposes) capable of executing instructions of computer program(s). Each processor may further have one or several cores. The survey server 200 also comprises memory 220 for storing instructions of the computer program(s) executed by the processing unit 210, data generated by the execution of the computer program(s), data received via a communication interface 230, etc. The survey server 200 may comprise several types of memories, including volatile memory, non-volatile memory, etc. The survey server 200 further comprises the communication interface 230, for exchanging data with other entities, such as a user device 320, a web server 340 and an analytic server 360. The survey server 200 exchanges data with the other entities through communication links, generally referred to as the Internet 300 for simplification purposes. Such communication links may include wired (e.g. a fixed broadband network) and wireless communication links (e.g. a cellular network or a Wi-Fi network).

In the rest of the description, we refer to instructions of a specific computer program. The instructions of the specific computer program implement the steps of the method 100 executed by the processing unit 210 of the survey server 200. The instructions are comprised in a computer program product (e.g. memory 220) and provide for performing a web survey based on behavioral data specific to a web page, when executed by the processing unit 210 of the survey server 200. The instructions of the computer program product are deliverable via an electronically-readable media, such as a storage media (e.g. a USB key or a CD-ROM) or via communication links 300 through the communication interface 230 of the survey server 200.

The survey server 200 may further comprise a display (e.g. a regular screen or a tactile screen) for displaying data processed and/or generated by the method 100, and a user interface (e.g. a mouse, a keyboard, a trackpad, a touchscreen, etc.) for allowing a user to interact with the survey server 200 when performing the method 100.

The user device 320 may consist of a computer, a laptop, a mobile device (e.g. smartphone, tablet, etc.), an Internet connected television, etc. The user device 320 is capable of retrieving web content from a web server 340 over the Internet 300, and displaying the retrieved web content to a user of the user device 320 via a web browser. The user device 320 comprises a processing unit (for executing instructions of a computer program implementing the web browser), memory, a communication interface (e.g. cellular interface, Wi-Fi interface, Ethernet interface, etc.) for retrieving the web content from the web server 340, a display for displaying the retrieved web content, and a user interface for allowing interactions with the user of the device 320. The components of the user device 320 are not represented in FIG. 2 for simplification purposes.

The web server 340 generally consists of a dedicated computer with high processing capabilities, capable of hosting one or a plurality of web sites. The web server 340 comprises a processing unit, memory, and a communication interface (e.g. Ethernet interface, Wi-Fi interface, etc.) for delivering web content of a hosted web site to the user device 320. The components of the web server 340 are not represented in FIG. 2 for simplification purposes.

Although a single user device 320 is represented in FIG. 2, a plurality of user devices 320 exchange data with the web server 340 in relation to a visit of a particular web site (hosted by the web server 340) by the plurality of user devices 320.

The analytic server 360 also generally consists of a dedicated computer with high processing capabilities for processing a large amount of data received from the user device 320 and/or web server 340. The received data include behavioral data related to visits of a particular web site, hosted by the web server 340 and visited by the user devices 320. The analytic server 360 comprises a processing unit, memory, and a communication interface (e.g. Ethernet interface, Wi-Fi interface, etc.) for receiving the behavioral data. The components of the analytic server 360 are not represented in FIG. 2 for simplification purposes.

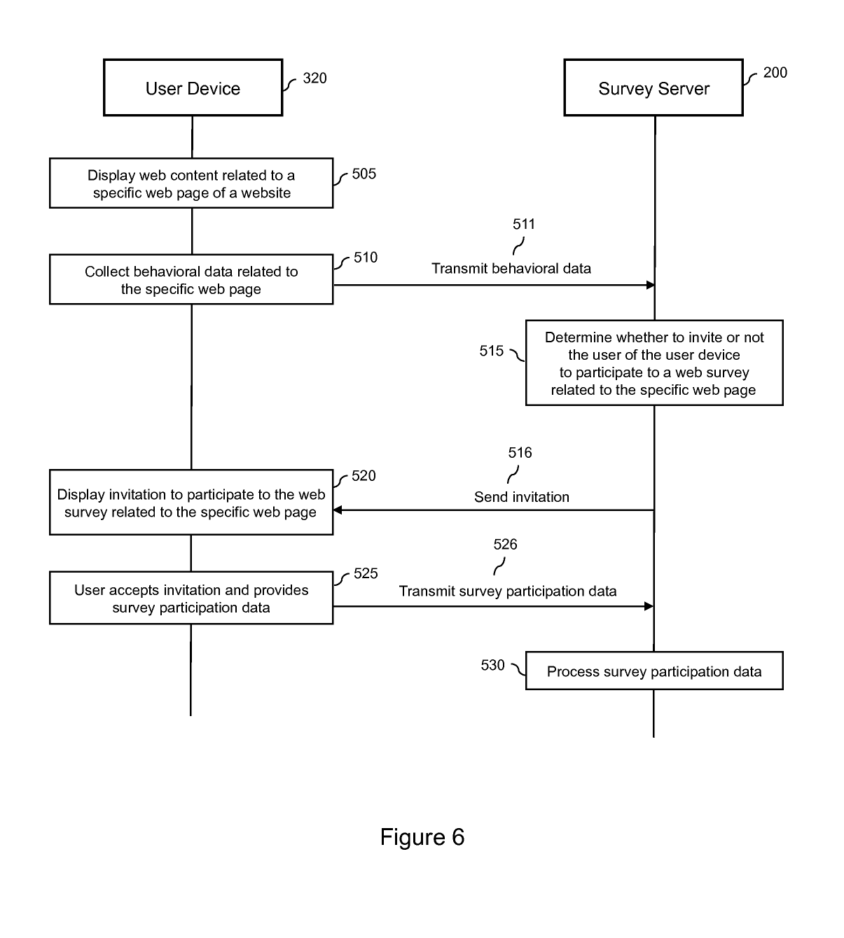

Reference is now made concurrently to FIGS. 2, 3, 4, 5 and 6. FIG. 6 represents steps performed by the user device 320 and the survey server 200 represented in FIG. 2 for performing a web survey based on behavioral data specific to a web page.

Referring particularly to FIGS. 2, 3 and 6, step 505 represents the display of a web content related to a specific web page (e.g. home_hardware) of a web site (e.g. http://www.ecommerce.com) on the display of the user device 320. The web content (e.g. text, image(s), video(s), icon(s), etc.) is displayed in a browsing window 420 of a browser 400 running on the user device 320. The web content is transmitted by the web server 340 hosting the web site to the user device 320 over the Internet 300. The interactions between the user device 320 and the web server 340 for exchanging web content are not represented in FIG. 6, since they are well known in the art.

Step 510 represents the collection of behavioral data related to the specific web page (e.g. home_hardware) of the web site (e.g. http://www.ecommerce.com) by the user device 320. For instance, the processing unit of the user device 320 executes a dedicated software for collecting the behavioral data. The various types of behavioral data which are collected in the context of the present disclosure will be detailed later in the description, when describing the method 100 represented in FIG. 1.

Step 511 represents the transmission by the user device 320 of the collected behavioral data to the survey server 200 over the Internet 300.

In an alternative embodiment, the web server 340 performs the collection of the behavioral data related to the specific web page of the web site, and transmits the collected behavioral data to the survey server 200 over the Internet 300. In still another alternative embodiment, the behavioral data are partially collected by the user device 320 and partially collected by the web server 340, before transmission to the survey server 200. In yet another alternative embodiment, at least some of the collected behavioral data are transmitted to the analytic server 360, where they may be processed for purposes specific to the analytic server 360, and further transmitted to the survey server 200, where they are processed according to the method 100 illustrated in FIG. 1.

Step 515 represents the processing of the behavioral data received by the survey server 200. The processing comprises determining whether to invite or not the user of the user device 320 to participate to a web survey related to the specific web page, as will be detailed later in the description when describing the method 100 represented in FIG. 1.

Although not represented in FIG. 6 for simplification purposes, the survey server 200 receives behavioral data related to the specific web page from a plurality of user devices 320. Thus, step 515 is performed for each one of the plurality of user devices 320, and a particular user device among the plurality of user devices 320 may be invited to participate to the web survey related to the specific web page based on the received behavioral data. For illustration purposes, we consider that the survey server 200 determines that the user device 320 represented in FIG. 6 shall be invited to participate to the web survey.

Referring particularly to FIGS. 2, 4 and 6, step 516 represents the sending by the survey server 200 of the invitation to participate to the web survey to the user device 320 over the Internet 300.

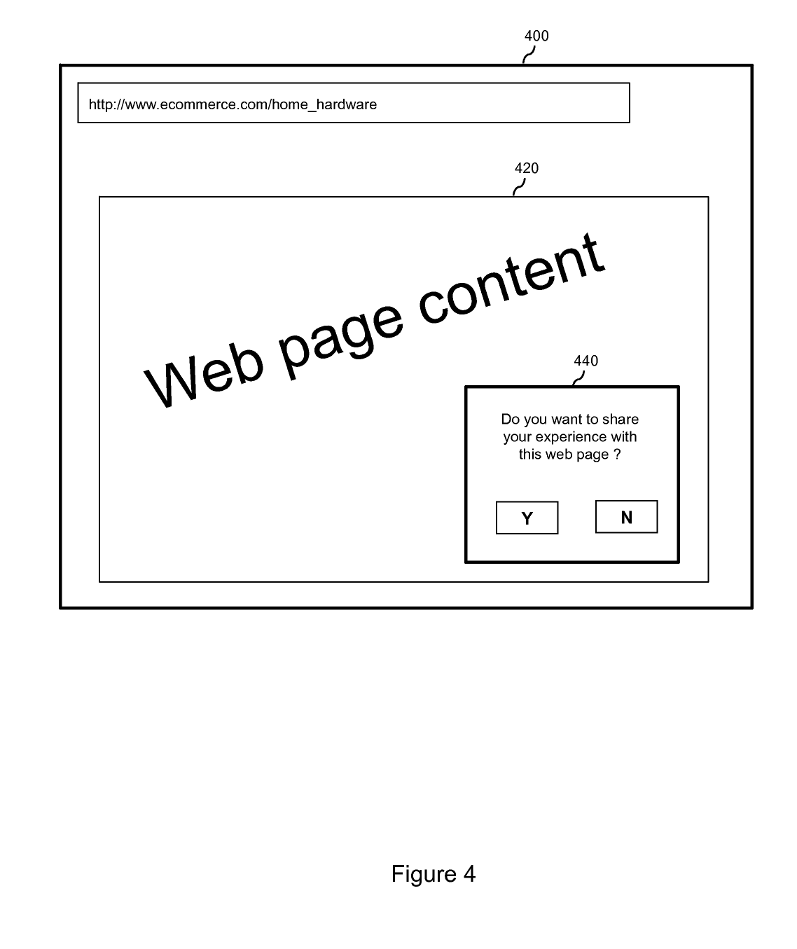

Step 520 represents the reception of the invitation to participate to the web survey by the user device 320 and the display by the browser 400 of a Graphical User Interface (GUI) 440 for inviting the user of the user device 320 to participate to the web survey. For example, the GUI 440 consists in an overlay popup window partially covering the browsing window 420, as illustrated in FIG. 4.

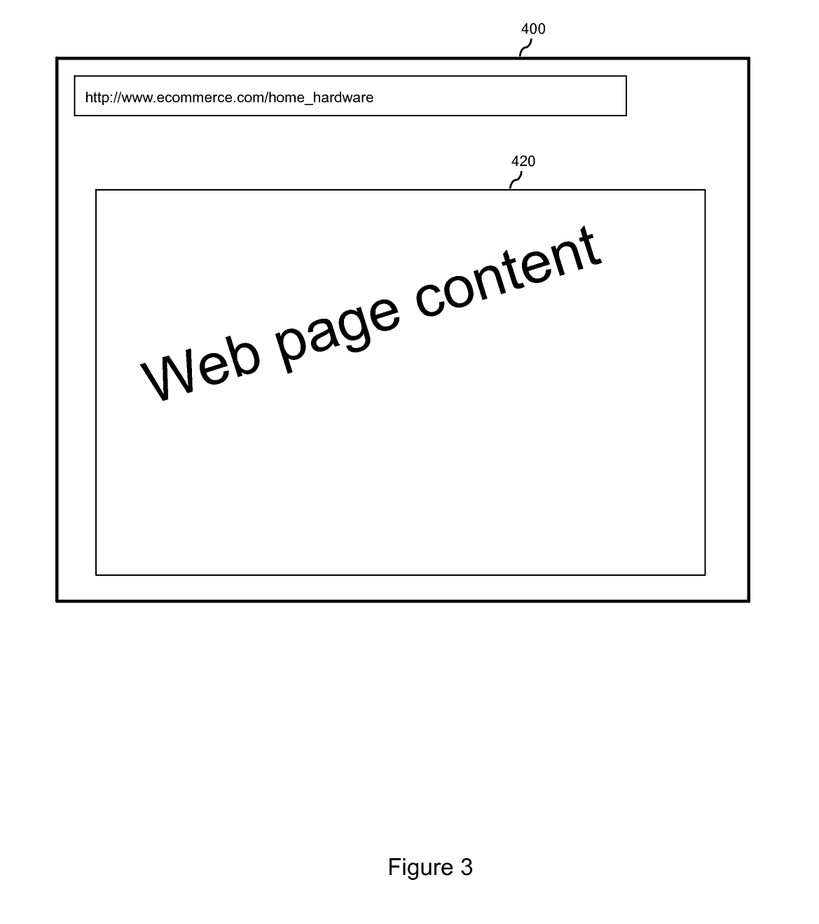

If the user of the user device 320 refuses the invitation, the GUI 440 is closed, and the user can pursue its browsing session as illustrated in FIG. 3. For illustration purposes, we consider that the user of the user device 320 accepts the invitation.

Referring particularly to FIGS. 2, 5 and 6, step 525 represents the user of the user device 320 accepting the invitation and providing survey participation data. For instance, step 525 comprises the display by the browser 400 of a Graphical User Interface (GUI) 460 for allowing the user of the user device 320 to provide the survey participation data. For example, the GUI 460 consists in an overlay popup window partially covering the browsing window 420, as illustrated in FIG. 4. The survey content displayed in the overlay popup window 460 comprises a clickable thumb up icon 462 for indicating a satisfying experience with the currently displayed web page (e.g. home_hardware), a clickable thumb down icon 464 for indicating a non-satisfying experience with the currently displayed web page, and a text entry widget 466 for optionally providing additional information (in a free text format) about the user experience with the currently displayed web page.

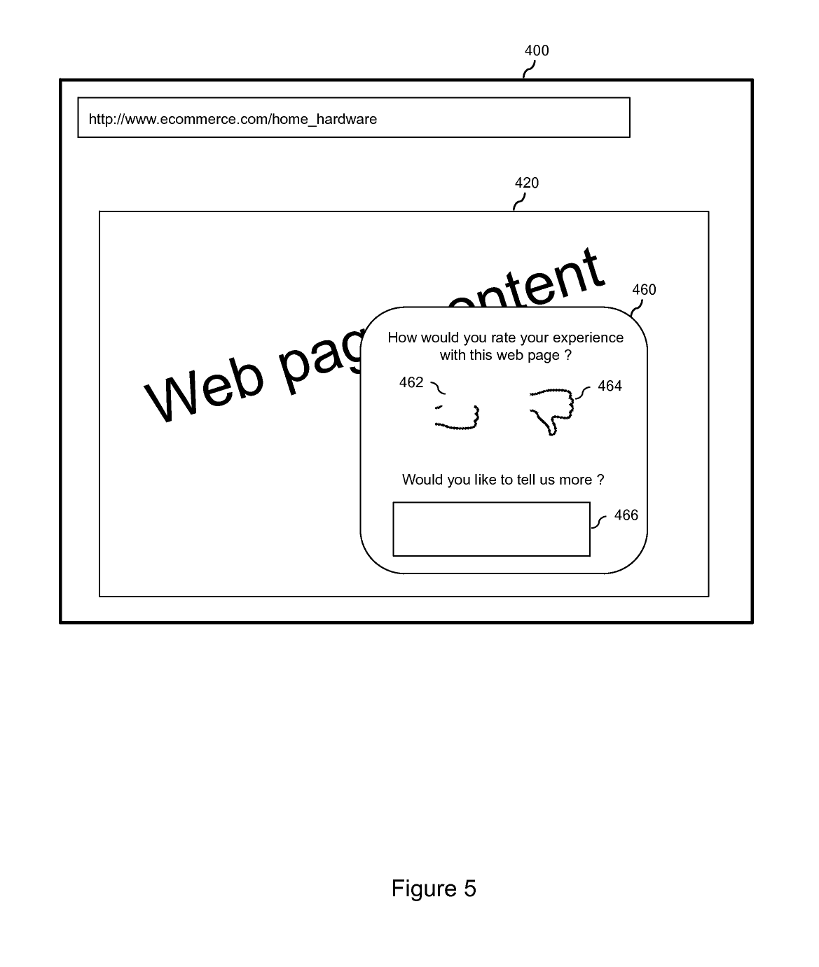

The aforementioned survey content is for illustration purposes only, and may be different. However, in a preferred embodiment, the survey content is short and focused (as illustrated in FIG. 5) to allow for a quick survey completion time and a minimal intrusion in the browsing experience of the user.

The survey content may be transmitted from the survey server 200 to the user device 320 along with the invitation to participate to the web survey at step 516. Alternatively, step 525 comprises a sending of a response (not represented in FIG. 6) by the user device 320 to the survey server 200, indicating that the user of the user device 320 has accepted the invitation. Step 525 also comprises a reception of a message (not represented in FIG. 6) containing the survey content, transmitted by the survey server 200 to the user device 320.

The interactions of the user with the GUI 460 generate survey participation data (e.g. click on one of the thumb up icon 462 or thumb down icon 464, text entered in the text entry widget 466), representative of the experience of the user with the specific web page.

Step 526 represents the transmission by the user device 320 of the survey participation data to the survey server 200 over the Internet 300, upon completion of the web survey by the user. For instance, the completion of the web survey by the user is indicated by a click on a button of the GUI 460 (not represented in FIG. 5). The GUI 460 is further closed, and the user can pursue its browsing session as illustrated in FIG. 3.

In an alternative embodiment, the GUI 440 of FIG. 4 is not displayed by the browser 400 at step 520. Instead, the GUI 460 is directly displayed by the browser 400 at step 520. In this case, the GUI 460 allows the user to refuse to participate to the web survey (e.g. via a discard button not represented in FIG. 5). Upon refusal to participate by the user, the GUI 460 is immediately closed, and the user can pursue its browsing session as illustrated in FIG. 3. Otherwise, the user can immediately participate to the web survey and provide survey participation data, by interacting with the GUI 460 as described previously.

Step 530 represents the processing of the survey participation data received by the survey server 200 (from a plurality of user devices 320). The processing may comprise generating a report based on the received survey participation data and/or updating reference behavioral data stored at the survey server 200, as will be detailed later in the description when describing the method 100 represented in FIG. 1.

A unique session identifier may be used by the survey server 200 and a specific user device 320 for uniquely identifying the specific user device 320 (e.g. when transmitting data from the specific user device 320 to the survey server 200 at steps 511 and 526). The unique session identifier can be generated by the survey server 200 (e.g. generation of a unique random number) and transmitted to the specific user device 320 before step 511. The unique session identifier can also be generated by the specific user device 320 (e.g. based on a unique characteristic of the user device 320). The unique session identifier can be stored in a cookie at the specific user device 320. Alternatively, a unique device identifier of the specific user device 320 (e.g. a Media Access Control (MAC) address, an International Mobile Station Equipment Identity (IMEI), an International Mobile Subscriber Identity (IMSI), etc.) can be used in place of (or complementarity to) the unique session identifier.

Referring back concurrently to FIGS. 1 and 2, the method 100 for performing a web survey based on behavioral data specific to a web page will be detailed.

The method 100 comprises the step 105 of collecting behavioral data related to a specific web page of a website from a plurality of user devices 320. The behavioral data are representative of a series of actions performed by a user of each of the plurality of user devices 320 while visiting the specific web page.

As mentioned previously, the website is hosted by the web server 340. Visiting the specific web page comprises transferring a web content corresponding to the specific web page from the web server 340 to the plurality of user devices 320 and displaying the web content on a display of the plurality of user devices 320. The user of each user device 320 can interact with the displayed web content via a user interface of the user device 320 to perform the series of actions.

In a particular aspect, the behavioral data are directly collected by the survey server 200. The behavioral data may be first gathered by the plurality of user devices 320, transmitted to the survey server 200 over the Internet 300, and received by the survey server 200 via its communication interface 230 (as illustrated in steps 510 and 511 of FIG. 6). Alternatively, the behavioral data are first gathered by the web server 340 hosting the web site, transmitted to the survey server 200 over the Internet 300, and received by the survey server 200 via its communication interface 230

In another particular aspect, the behavioral data are collected by a third party server, such as the analytic server 360. The behavioral data are first gathered by either the plurality of user devices 320 or the web server 340, and then transmitted to the analytic server 360 over the Internet 300. The analytic server 360 may use the behavioral data to perform its own analysis of the behaviors of the users of the user devices 320, which is out of the scope of the present disclosure. The behavioral data are further transmitted by the analytic server 360 to the survey server 200 over the Internet 300, and the behavioral data are received by the survey server 200 via its communication interface 230. In a particular embodiment, the analytic server 360 may be integrated with the web server 340. In another particular embodiment, the analytic server 360 may be integrated with the survey server 200.

The behavioral data received via the communication interface 230 of the survey server 200 can be either processed immediately by its processing unit 210 or stored in its memory 220 for later use. For instance, behavioral data related to the specific web page may be received in several bundles from a particular user device 320, and aggregated in memory 220 using a unique identifier of the particular user device 320 (e.g. the previously mentioned unique session identifier or unique device identifier).

The method 100 comprises the step 110 of comparing by the processing unit 210 of the survey server 200 the behavioral data collected from the plurality of user devices 320 with reference behavioral data. The reference behavioral data are stored in memory 220, and may consist of either one of (or a combination of) static reference behavioral data (their value is pre-defined and does not change) or dynamic reference behavioral data, as will be detailed later in the description (their value can change).

Before performing step 110, the processing unit 210 may perform a filtering of the collected behavioral data, and discard some of the collected behavioral data based on pre-determined criteria. The criteria may include at least one of the following: incomplete behavioral data, erroneous behavioral data, irrelevant behavioral data, etc.

The method 100 comprises the step 115 of determining by the processing unit 210 whether to invite or not the user of a particular user device among the plurality of user devices 320 to participate to a web survey related to the specific web page, based on a result of the comparison performed at step 110. Steps 110 and 115 of the method 100 correspond to step 515 represented in FIG. 6.

In a particular aspect, the behavioral data collected at step 105 comprise one or more metrics and the reference behavioral data comprise corresponding reference values for the one or more metrics. A particular metric among the one or more metrics may be calculated by the processing unit 210, based on data comprised in the behavioral data collected at step 105. Alternatively, the behavioral data collected at step 105 directly comprise the particular metric, which has been calculated by the user device 320 (or alternatively by the web server 340 or analytic server 360, based on where the behavioral data are initially gathered).

In another particular aspect, the behavioral data collected at step 105 comprise one or more metrics, and the comparison performed at step 110 comprises comparing the one or more metrics for each of the user devices 320 with the corresponding reference values. As mentioned previously, the corresponding reference values may be static or dynamic.

Examples of metrics include at least one of the following: a time spent on the specific web page, a scrolling activity on the specific web page, a backtracking activity on the specific web page, etc.

The time spent on the specific web page is a duration which can be measured in seconds.

The scrolling activity on the specific web page can be measured by the number of times the user of the user device 320 has scrolled the specific web page either horizontally or vertically (the action of scrolling a web page is well known in the art).

The backtracking activity on the specific web page can be measured by the number of times the user of the user device 320 has come back to the specific web page from another web page of the web site during a pre-defined interval of time.

The determination (performed at step 115) to invite the user of a particular user device to participate to the web survey is made when at least one of the metrics for the particular user device deviates from its corresponding reference value by a pre-determined amount. Thus, a single metric or a combination of metrics may be taken into consideration for the determination performed at step 115. For a particular type of metric, the deviation from the corresponding reference value by a pre-determined amount may consist in being lower than a given value, being higher than a given value, being outside of an interval of values, etc.

Following are examples of conditions for inviting the user of a particular user device to participate to the web survey: the time spent on the specific web page is higher than 30 seconds, the scrolling activity on the specific web page is higher than 5 times (more than 5 vertical or horizontal scrolls), the time spent on the specific web page is higher than 20 seconds AND the scrolling activity on the specific web page is higher than 3 times, the time spent on the specific web page is higher than 30 seconds OR the scrolling activity on the specific web page is higher than 5 times, etc.

In this particular aspect, the determination whether to invite or not the user of a particular user device to participate to the web survey is performed for each user device of the plurality of user devices 320 from which behavioral data are collected at step 105, and is based on the collected behavioral data (more specifically on the one or more metrics) of the particular user device. Behavioral data collected from other user devices 320 are not taken into consideration for the determination.

In still another particular aspect, the behavioral data collected at step 105 comprise one or more metrics, and the comparison performed at step 110 comprises comparing mean values of the one or more metrics with corresponding reference values. The mean values of the one or more metrics are calculated for the plurality of user devices for which behavioral data have been collected.

Examples of metrics for which a mean value can be calculated include at least one of the following: a time spent on the specific web page, a scrolling activity on the specific web page, a backtracking activity on the specific web page, an action firing activity on the specific web page, a comment card filing activity, an exit activity on the specific web page, a hit activity on the specific web page, etc.

The action firing activity on the specific web page can be measured by the number of times the user of the user device 320 has performed a specific action among a plurality of pre-defined actions (e.g. clicking on a download button, accessing a cart, etc.). The plurality of pre-defined actions depends on the design and function of the specific web page.

The comment card filing activity can be measured by the number of times the user of the user device 320 has filed a comment card. In a particular embodiment, only comment card(s) associated to the specific web page may be taken into consideration. In another embodiment, comment card(s) associated to the entire website are taken into consideration.

The exit activity on the specific web page can be measured by an occurrence of the user of the user device 320 exiting the website from the specific web page. For example, the exit activity has a value of 1 if an occurrence of exiting via the specific web page occurs, and 0 otherwise.

The hit activity on the specific web page can be measured by a number of occurrences of the user of the user device 320 accessing the specific web page.

The mean time spent on the specific web page is the value of the time spent on the specific web page averaged over each of the user devices 320 mentioned at step 105. The mean scrolling activity on the specific web page is the value of the scrolling activity on the specific web page averaged over each of the user devices 320 mentioned at step 105. The mean backtracking activity on the specific web page is the value of the backtracking activity on the specific web page averaged over each of the user devices 320 mentioned at step 105. The mean action firing activity on the specific web page is the value of the action firing activity on the specific web page averaged over each of the user devices 320 mentioned at step 105. The mean comment card filing activity is the value of the comment card filing activity (for the specific web page only or for the entire website) averaged over each of the user devices 320 mentioned at step 105. The mean exit activity on the specific web page is the value of the exit activity on the specific web page averaged over each of the user devices 320 mentioned at step 105. The mean hit activity on the specific web page is the value of the hit activity on the specific web page averaged over each of the user devices 320 mentioned at step 105.

The determination (performed at step 115) to invite the user of a particular user device to participate to the web survey is made when the calculated mean value of at least one of the metrics deviates from its corresponding reference value by a pre-determined amount. As mentioned previously, a mean value of a single metric or a combination of mean values of several metrics may be taken into consideration for the determination performed at step 115. Furthermore, the deviation of the mean value of the metric from the corresponding reference value by a pre-determined amount may consist in being lower than a given value, being higher than a given value, being outside of an interval of values, etc.

Following are examples of conditions for inviting the user to participate to the web survey: the mean time spent on the specific web page is higher than 30 seconds, the mean action firing activity on the specific web page is higher than 1.5, the mean time spent on the specific web page is higher than 20 seconds AND the mean hit activity on the specific web page is lower than 2, the mean time spent on the specific web page is higher than 30 seconds OR the mean exit activity on the specific web page is higher than 0.5, etc.

In this particular aspect, the determination whether to invite or not the user of a particular user device to participate to the web survey takes into consideration (via the calculated mean value(s) of the one or more metrics) behavioral data previously collected from other user devices 320 at step 105. The behavioral data collected from the particular user device may be taken into consideration in the calculation of the mean value(s) based on which the determination is made. Alternatively, the behavioral data collected from the particular user device are not taken into consideration in the calculation of the mean value(s) based on which the determination is made. The mean value(s) taking into consideration the behavioral data collected from the particular user device are calculated afterwards and used for the following user devices 320 for which behavioral data are collected at step 105. In this second alternative, the decision process for inviting a particular user device is simpler and faster: as long as the mean value(s) is (are) out of the pre-determined boundaries, each new user device 320 for which behavioral data are collected at step 105 is a candidate for receiving an invitation to the participate to the web survey.

The calculation of the mean value for a specific type of metric (e.g. time spent, scrolling activity, etc.) may take into consideration behavioral data collected at step 105 over a pre-determined period of reference, for instance over the last 15 minutes. The period of reference can be different for each type of metric. The period of reference may be modified by an administrator of the survey server 200, for instance lowered if an issue is currently being experienced with the specific web page (the detection of the issue being based on received survey participation data as will be detailed later in the description). In order to be capable of calculating the mean value for a specific type of metric, the behavioral data collected at step 105 may be stored in the memory 220 for a duration compatible with a maximum possible value of the period of reference for the specific type of metric.

In yet another particular aspect, the determination whether to invite or not the user of a particular user device to participate to the web survey may be based on a combination of the two aforementioned criteria: at least one of the metrics for the particular user device deviates from its corresponding reference value by a pre-determined amount, and the calculated (over a plurality of user devices) mean value of at least one of the metrics deviates from its corresponding reference value by a pre-determined amount.

In another particular aspect, the comparison performed at step 110 may take into consideration other metrics. For example, a collocation statistic for the specific web page can be measured by an occurrence of the user of the user device 320 visiting the specific web page and another determined web page of the website. The collocation statistic is increased by a value of 1 if an occurrence occurs, and 0 otherwise. The collocation statistic is calculated across each of the user devices 320, and compared to a reference value. Several collocation statistics can be measured for different determined web pages of the web site, with respect to the specific web page.

The method 100 comprises the step 120 of sending an invitation to participate to the web survey to the particular user device 320 when a determination to invite the user of the particular user device 320 to participate to the web survey has been made at step 115. The invitation is sent by the processing unit 210 of the survey server 200 via its communication interface 230, and transmitted over the Internet 300 to the particular user device 320.

The sending of the invitation to the particular user device 320 may depend on an invitation rate for the web survey. The invitation rate limits the number of candidates among the particular user devices 320 determined at step 115, for which an invitation is effectively sent. Thus, the invitation rate limits the number of particular user devices 320 receiving the invitation to a reasonable sample, allowing effective collection of survey participation data while minimizing interferences with the users of the particular user devices 320 during their visit of the website. The invitation rate represents the probability to send the invitation to a particular user device 320, and can be expressed as a percentage (e.g. 30%). Thus, the processing unit 210 may generate a random number, and effectively send the invitation based on the random number and the invitation rate. For example, a random number between 1 and 100 is generated. The invitation is sent to a particular user device 320 for any random number between 1 and 30 and not sent for any random number between 31 and 100.

The method 100 comprises the step 125 of receiving survey participation data from the particular user device 320 in response to the invitation to participate to the web survey. The survey participation data are transmitted over the Internet 300 by the particular user device 320, and received by the processing unit 210 of the survey server 200 via its communication interface 230. However, if the user of the particular user device 320 refuses to participate to the survey, no survey participation data are received from this particular user device 320.

Steps 120 and 125 of the method 100 respectively correspond to steps 516 and 526 of FIG. 6, which illustrate in combination with steps 520 and 525 of FIG. 6 the execution of the web survey from the perspective of the particular user device 320, as has been previously detailed in relation to FIG. 6.

The goal of the web survey is to collect information from the users of the particular user devices 320 which have been invited to participate, in order to evaluate their degree of satisfaction with their browsing session of the specific web page. Optional feedback in a free text format may be collected for this purpose. The collected information can be exploited at the survey server in various concurrent or complementary manners (e.g. steps 130 and 135 of the method 100).

In a particular aspect, the method 100 comprises the step 130 of generating a report, based on the survey participation data received from a plurality of the particular user devices 320. The report may comprise a mean satisfaction rate with respect to the specific web page, calculated by averaging an individual satisfaction rate provided by each user of the plurality of the particular user devices 320. The individual satisfaction rate can be expressed via two exclusive indicators (as illustrated in FIG. 5 with the thumb up 462 and thumb down 464 icons), or via a rating scale (e.g. integers from 1 to 10). The report may also include feedback expressed in the form of free text format, for instance a compilation of the feedback from the users having experienced the worst user experience as expressed by their individual satisfaction rates. The report may also identify a specific issue with the specific web page, the specific issue being selectable among a list of pre-defined potential issues when answering to the web survey. Additional content may be added to the report, based on other type(s) of information contained in the survey participation data, as is well known in the art of performing web surveys to evaluate the user experience and satisfaction of visitors of a website.

The report is generated by the processing unit 210 of the survey server 200, and is transmitted over the Internet 300 (substantially in real time) to an owner or an administrator of the website, via the communication interface 230 (e.g. in the form of an email alert). Thus, the owner/administrator of the website can take immediate actions to solve an issue with the specific web page of the website. The content of the report (if sufficiently detailed) may help in identifying the specific issue affecting the specific web page. Alternatively or concurrently, the report is stored in the memory 220 of the survey server 200, and can viewed or transmitted later.

In another particular aspect, the method 100 comprises the step 135 of updating (by the processing unit 210) the reference behavioral data (stored in the memory 220) based on the survey participation data and the behavioral data collected (via the communication interface 230) from the particular user device 320. For instance, if the survey participation data indicate that the user of the particular user device 320 is satisfied with its browsing experience of the specific web page, the reference behavioral data are not updated based on the behavioral data collected from the particular user device 320. But if the survey participation data indicate that the user of the particular user device 320 is not satisfied with its browsing experience of the specific web page, the reference behavioral data are updated based on the behavioral data collected from the particular user device 320. In the latter case, if the behavioral data comprise metrics, the reference values of the metrics can be updated by taking into consideration values of the metrics corresponding to the behavioral data collected from the particular user device 320 (for which an issue with the specific web page has been reported via the web survey). Consequently, the reference values of the metrics are automatically updated to be more accurately representative of users having experienced issue(s) with the specific web page, and are therefore more accurate for evaluating future similar issue(s) with the specific web page. For instance, for each metric, the reference value of the metric may consist of an average and a standard deviation calculated over the values of the metrics collected from the particular user device 320 for which an issue with the specific web page has been reported via the web survey. The average and standard deviation are used to evaluate (at steps 110 and 120) a value of the metric received at step 105. For example, in the case of the time spent on a specific web page, a first average value of the time spent calculated for all the user devices 320 is 20 seconds (it is only partially representative since it does not discriminate between users experiencing an issue with the specific web page and users not experiencing an issue). A second average value of the time spent calculated for the particular user devices 320 for which an issue with the specific web page has been reported via the web survey is 40 seconds. This second value of 40 seconds is taken as the reference value for the time spent on the specific web page (used at step 110 of the method 100), since it is representative of the particular users experiencing an issue with the specific web page.

In still another particular aspect, the survey server 200 is capable of applying the method 100 to several web pages of the same web site, and furthermore to different web sites. For this purpose, a unique identifier of a specific web page of a particular web site (e.g. the Uniform Resource Locator (URL) of the specific web page) is used for identifying the specific web page when performing the various steps of the method 100. For instance, the behavioral data collected at step 105 are identified with the unique identifier of each specific web page. Furthermore, the reference behavioral data used at step 110 can be specific for each of (or at least some of) the specific web pages for which the method 100 is performed.

In yet another particular aspect, step 110 of the method 100 takes into consideration contextual data of the user devices 320. For instance, different reference behavioral data can be used, based on the contextual data. The contextual data may comprise at least one of the following: a hardware configuration of the user device 320 (e.g. screen characteristics), a software configuration of the user device 320 (e.g. operating system, browser, etc.), a user configuration of the user device 320 (e.g. language, country, etc.). The contextual data are collected from the user devices 320 at step 105, in a similar manner to the behavioral data. For example, based on various sizes of the screens of the user devices 320, different reference values can be defined for the time spent on the specific web page, the scrolling activity on the specific web page, etc.

Although the present disclosure has been described hereinabove by way of non-restrictive, illustrative embodiments thereof, these embodiments may be modified at will within the scope of the appended claims without departing from the spirit and nature of the present disclosure.

1. A method for performing a web survey based on behavioral data specific to a web page, comprising:
collecting behavioral data related to a specific web page of a website from a plurality of user devices, the behavioral data being representative of a series of actions performed by users of the plurality of user devices while visiting the specific web page;
comparing by a processing unit of a survey server the behavioral data collected from the plurality of user devices with reference behavioral data;
determining by the processing unit whether to invite or not one of the users to participate to a web survey based on a result of the comparison, the web survey providing for collecting feedback from the invited user with respect to his user experience when visiting the specific web page;
sending an invitation to participate to the web survey to the user device of the invited user if the determination to invite is positive;
receiving survey participation data from the user device of the invited user in response to the invitation to participate to the web survey; and
updating the reference behavioral data based on the survey participation data and the behavioral data collected from the user device of the invited user.

2. The method of claim 1, wherein the behavioral data comprise one or more metrics, the reference behavioral data comprise corresponding reference values, and the comparison comprises comparing the one or more metrics for each of the user devices with the corresponding reference values.

3. The method of claim 2, wherein a determination to invite a user of a particular user device to participate to the web survey is made when at least one of the metrics for the particular user device deviates from its corresponding reference value by a pre-determined amount.

4. The method of claim 2, wherein the one or more metrics comprise at least one of the following: a time spent on the specific web page, a scrolling activity on the specific web page, and a backtracking activity on the specific web page.

5. The method of claim 1, wherein the behavioral data comprise one or more metrics, the reference behavioral data comprise corresponding reference values, and the comparison comprises comparing mean values of the one or more metrics with the corresponding reference values, the mean values being calculated for the plurality of user devices for which behavioral data have been collected.

6. The method of claim 5, wherein a determination to invite a user of a particular user device to participate to the web survey is made when the calculated mean value of at least one of the metrics deviates from its corresponding reference value by a pre-determined amount.

7. The method of claim 5, wherein the one or more metrics comprise at least one of the following: a time spent on the specific web page, a scrolling activity on the specific web page, a backtracking activity on the specific web page, an action firing activity on the specific web page, a comment card filing activity, an exit activity on the specific web page, and a hit activity on the specific web page.

8. (canceled)

9. The method of claim 1, wherein the sending of the invitation to the user device of the invited user depends on an invitation rate for the web survey.

10. (canceled)

11. The method of claim 10, further comprising generating a report based on the survey participation data received from a plurality of user devices of a plurality of invited users, the report comprising at least one of the following: a mean satisfaction rate with respect to the specific web page calculated by averaging individual satisfaction rates provided in the survey participation data, feedback expressed in free text form in the survey participation data, and an identification of a specific issue with the specific web page provided in the survey participation data.

12. (canceled)

13. A non-transitory computer program product comprising instructions deliverable via an electronically-readable media, such as storage media and communication links, which when executed by a processing unit of a survey server provide for performing a web survey based on behavioral data specific to a web page by:
comparing behavioral data collected from a plurality of user devices with reference behavioral data stored in a memory of the survey server, the collected behavioral data being representative of a series of actions performed by users of the plurality of user devices while visiting a specific web page of a website;
determining whether to invite or not one of the users to participate to a web survey based on a result of the comparison, the web survey providing for collecting feedback from the invited user with respect to his user experience when visiting the specific web page;
sending an invitation to participate to the web survey to the user device of the invited user if the determination to invite is positive;
receiving survey participation data from the user device of the invited user in response to the invitation to participate to the web survey; and
updating the reference behavioral data based on the survey participation data and the behavioral data collected from the user device of the invited user.

14. The computer program product of claim 13, wherein the instructions executed by the processing unit further collect the behavioral data from the plurality of user devices via a communication interface of the survey server.

15. A survey server, comprising:
a communication interface for:
exchanging data with user devices;
memory for:
storing reference behavioral data;
a processing unit for:
comparing behavioral data collected from a plurality of user devices with the reference behavioral data, the collected behavioral data being representative of a series of actions performed by users of the plurality of user devices while visiting a specific web page of a website;
determining whether to invite or not one of the users to participate to a web survey based on a result of the comparison, the web survey providing for collecting feedback from the invited user with respect to his user experience when visiting the specific web page;
sending an invitation to participate to the web survey to the user device of the invited user if the determination to invite is positive;
receiving survey participation data from the user device of the invited user in response to the invitation to participate to the web survey; and
updating the reference behavioral data based on the survey participation data and the behavioral data collected from the user device of the invited user.

16. The survey server of claim 15, wherein the processing unit further collects the behavioral data from the plurality of user devices via the communication interface.

17. The survey server of claim 15, wherein the behavioral data comprise one or more metrics, the reference behavioral data comprise corresponding reference values, and the comparison comprises comparing the one or more metrics for each of the user devices with the corresponding reference values, the one or more metrics comprising at least one of the following: a time spent on the specific web page, a scrolling activity on the specific web page, and a backtracking activity on the specific web page.

18. The survey server of claim 15, wherein the behavioral data comprise one or more metrics, the reference behavioral data comprise corresponding reference values, and the comparison comprises comparing mean values of the one or more metrics with the corresponding reference values, the mean values being calculated for the plurality of user devices for which behavioral data have been collected, the one or more metrics comprising at least one of the following: a time spent on the specific web page, a scrolling activity on the specific web page, a backtracking activity on the specific web page, an action firing activity on the specific web page, a comment card filing activity, an exit activity on the specific web page, and a hit activity on the specific web page.

19. (canceled)

20. The survey server of claim 15, wherein the processing unit further generates a report based on the survey participation data received from a plurality of user devices of a plurality of invited users, the report comprising at least one of the following: a mean satisfaction rate with respect to the specific web page calculated by averaging individual satisfaction rates provided in the survey participation data, feedback expressed in free text form in the survey participation data, and an identification of a specific issue with the specific web page provided in the survey participation data.

21. The computer program product of claim 13, wherein the behavioral data comprise one or more metrics, the reference behavioral data comprise corresponding reference values, and the comparison comprises comparing the one or more metrics for each of the user devices with the corresponding reference values, the one or more metrics comprising at least one of the following: a time spent on the specific web page, a scrolling activity on the specific web page, and a backtracking activity on the specific web page.

22. The computer program product of claim 13, wherein the behavioral data comprise one or more metrics, the reference behavioral data comprise corresponding reference values, and the comparison comprises comparing mean values of the one or more metrics with the corresponding reference values, the mean values being calculated for the plurality of user devices for which behavioral data have been collected, the one or more metrics comprising at least one of the following: a time spent on the specific web page, a scrolling activity on the specific web page, a backtracking activity on the specific web page, an action firing activity on the specific web page, a comment card filing activity, an exit activity on the specific web page, and a hit activity on the specific web page.

23. The computer program product of claim 13, wherein the instructions executed by the processing unit further generate a report based on the survey participation data received from a plurality of user devices of a plurality of invited users, the report comprising at least one of the following: a mean satisfaction rate with respect to the specific web page calculated by averaging individual satisfaction rates provided in the survey participation data, feedback expressed in free text form in the survey participation data, and an identification of a specific issue with the specific web page provided in the survey participation data.
